(19) United States
(12) Patent Application Publication
(10) Pub. No.: US 2006/0197849 A1
(43) Pub. Date: Sep. 7, 2006

(54) Methods, electronic devices, and computer program products for processing images using multiple image buffers

(76) Inventor: Mats Wernersson, Helsingborg (SE)

Correspondence Address: MYERS BIGEL SIBLEY & SAJOVEC, P.A., P.O. BOX 37428, RALEIGH, NC, 27627, US

(21) Appl. No.: 11/070,774

(22) Filed: Mar. 2, 2005

(51) Int. Cl. H04N 5/76

(52) U.S. Cl. 348/231.99

(57) ABSTRACT

An electronic device is operated by providing a plurality of buffers. Consecutive images are stored in respective ones of the plurality of buffers and one or more of the stored images is selected for output responsive to user input.

### BACKGROUND OF THE INVENTION

The present invention relates to image processing systems, and, more particularly, to methods, electronic devices, and computer program products for processing images using multiple image buffers.

Mobile terminals, such as cellular phones, may be equipped with digital camera functionality. When a user aims the camera at a scene, the camera may work in a viewfinder mode. In this mode, the output image size may be smaller and the image quality may be less than the maximum size and resolution, respectively, that may be provided by the camera. The output format may correspond to the size of the viewfinder image in the display. The smaller format may indicate less image data and a higher frame rate may be used, e.g., approximately 15-30 frames per second.

When a user presses the release button on the camera, the camera shifts to capture mode. In a conventional camera, it may take one extra image frame to switch to full resolution at such time the camera captures a full resolution image and sends the full resolution image to the display. Unfortunately, the time lag between the time that the user presses the release button to capture an image and the time that the camera captures an image frame may result in the user not getting the image that he or she desired. For example, the subject may have moved during that time period. Moreover, the image is captured at a time when camera shake may be more severe. The user has just pressed the release button, which may cause camera shake, and the user may have started to move the camera thinking that the image had already been captured.

### SUMMARY OF THE INVENTION

According to some embodiments of the present invention, an electronic device is operated by providing a plurality of buffers. Consecutive images are stored in respective ones of the plurality of buffers and one or more of the stored images is selected for output responsive to user input.

In other embodiments of the present invention, storing the consecutive images comprises compressing the consecutive images.

In still other embodiments of the present invention, storing the consecutive images further comprises scaling the consecutive images before compressing the consecutive images.

In still other embodiments of the present invention, the consecutive images are scaled and the scaled consecutive images are output before selecting one or more of the stored images for output.

In still other embodiments of the present invention, the plurality of buffers comprises a circular queue.

In still other embodiments of the present invention, selecting one of the stored images for output comprises selecting the image that was stored in the plurality of buffers immediately before the user input responsive to the user input.

In still other embodiments of the present invention, selecting one or more of the stored images for output comprises displaying the stored images responsive to the user input and receiving a selection of one or more of the stored images from the user responsive to displaying the stored images.

In still other embodiments of the present invention, the electronic device is a mobile terminal comprising a camera and/or a video recorder.

Although described above primarily with respect to method aspects of the present invention, it will be understood that the present invention may be embodied as methods, electronic devices, and/or computer program products.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a mobile terminal in accordance with some embodiments of the present invention;

FIG. 2 is a block diagram that illustrates a hardware/software architecture that may be used in electronic devices, such as the mobile terminal of FIG. 1, in accordance with some embodiments of the present invention;

FIG. 3 is a block diagram of image buffers in accordance with some embodiments of the present invention; and

FIG. 4 is a flowchart that illustrates operations for processing image data in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. Furthermore, as used herein, the term “image” means data that comprises a representation of a physical object formed by a lens, mirror, or other optical instrument.

For purposes of illustration, embodiments of the present invention are described herein in the context of a mobile terminal comprising a camera and/or a video recorder. It will be understood, however, that the present invention is not limited to such embodiments and may be embodied generally as an electronic device that comprises image-processing functionality.

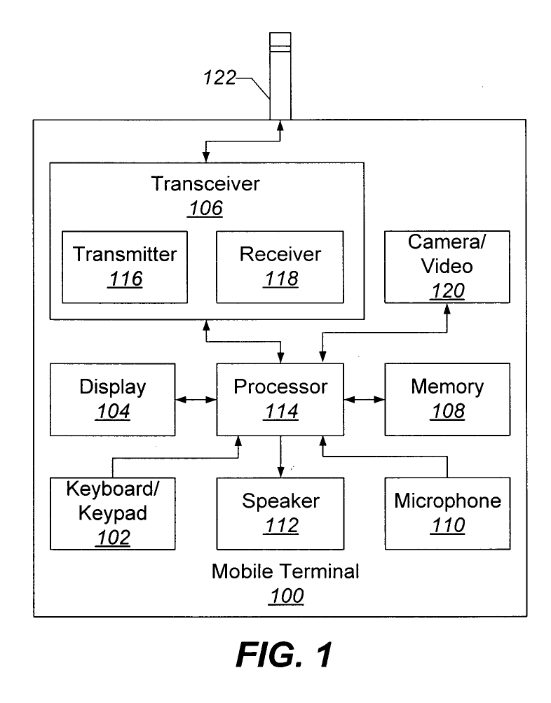

Referring now to FIG. 1 an exemplary mobile terminal 100, in accordance with some embodiments of the present invention, includes a keyboard/keypad 102, a display 104, a transceiver 106, a memory 108, a microphone 110, and a speaker 112 that communicate with a processor 114. The transceiver 106 typically includes a transmitter circuit 116 and a receiver circuit 118 which cooperate to transmit and receive radio frequency signals to base station transceivers via an antenna 122. The memory 108 may represent a hierarchy of memory that may include volatile and/or non-volatile memory, such as removable flash, magnetic, and/or optical rewritable non-volatile memory. The radio frequency signals transmitted between the mobile terminal 100 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The mobile terminal 100 may further comprise a camera/video module 120, which may be configured to capture and display images in accordance with some embodiments of the present invention. The foregoing components of the mobile terminal 100 may be included in many conventional mobile terminals and their functionality is generally known to those skilled in the art.

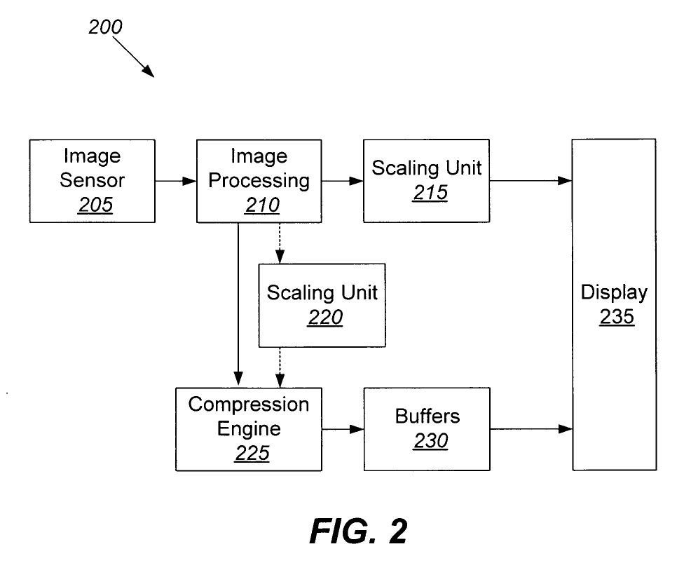

FIG. 2 is a block diagram that illustrates a camera/video module 200 that may be used, for example, to implement the camera/video module 120 of FIG. 1, in accordance with some embodiments of the present invention. The camera/video module 200 comprises an image sensor 205, an image processing unit 210, a first scaling unit 215, a second scaling unit 220, a compression engine 225, a plurality of buffers 230, and a display 235 that are configured as shown. The image sensor 205 provides raw image data to the image-processing unit 210. The image-processing unit 210 may be configured to process the raw image data by performing such functions as, for example, color interpolation, gamma correction, and sharpening. If the camera/video recorder has a viewfinder mode, then the image output from the image-processing unit 210 may be reduced in size by the scaling unit 215 for display on the display 235. In various embodiments of the present invention, the small image format for viewfinder mode may be obtained through sub sampling via the image sensor 205 and/or scaling by the scaling unit 215.

According to some embodiments of the present invention, the image output from the image-processing unit 210 is provided in parallel to both the scaling unit 215 associated with the viewfinder mode as well as a compression engine 225, which is associated with the capture of an image responsive to user input. The compression engine 225 may be a JPEG compression engine in accordance with some embodiments of the present invention. The compression engine 225 is configured to compress the image output from the image-processing unit 210. The compressed images output from the compression engine may then be stored in the plurality of buffers 230.

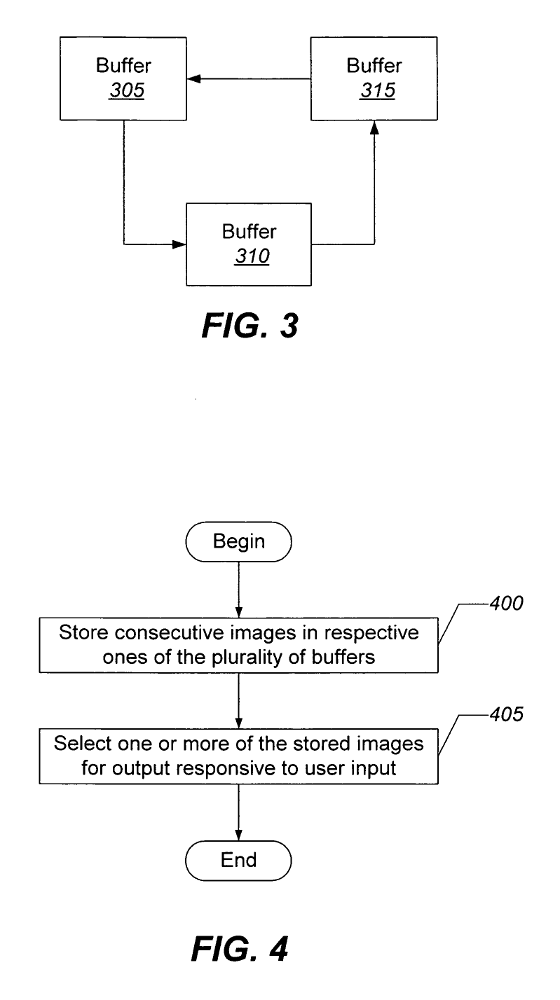

The buffers are illustrated, for example, in FIG. 3. The buffers 230 may be configured as a circular queue of image buffers. In the example shown in FIG. 3, three images may be stored in buffers 305, 310, and 315. A compressed image output from the compression engine 225 may first be stored in buffer 305. A subsequent image is stored in buffer 310. A third image is then stored in buffer 315. When the compression engine 225 generates a fourth image, it is stored in buffer 305 thereby overwriting the first image that was stored there. Although three image buffers are illustrated in FIG. 3, it will be understood that the image buffers may comprise two or more image buffers.

If images smaller than the maximum resolution are desired for capture, then an optional scaling unit 220 may be inserted between the image-processing unit 210 and the compression engine 225.

The display 235 may represent both a display and a microprocessor controller, such as the processor 114 of FIG. 1. When the camera/video recorder is in viewfinder mode, then the output of the scaling unit 215 may be displayed on the display 235. When a user provides input to capture an image, however, then the output of one of the images stored in the buffers 230 may be output on the display 235 and may also be stored in memory so that it may be retained for a longer period of time.

Although FIG. 2 illustrates an exemplary hardware/software architecture that may be used in mobile terminals, electronic devices, and the like for processing image data, it will be understood that the present invention is not limited to such a configuration but is intended to encompass any configuration capable of carrying out operations described herein. Moreover, the functionality of the hardware/software architecture of FIG. 2 may be implemented as a single processor system, a multi-processor system, or even a network of stand-alone computer systems, in accordance with various embodiments of the present invention.

Computer program code for carrying out operations of devices and/or systems discussed above with respect to FIG. 2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, data processing systems, and/or computer program products in accordance with some embodiments of the invention.

These flowchart and/or block diagrams further illustrate exemplary operations of processing image data in accordance with various embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Referring now to FIGS. 4 and 2, operations processing image data, in accordance with some embodiments of the present invention, begin at block 400 where consecutive images are stored in respective ones of the plurality of buffers 230 at block 400. At block 405, one of the stored images is selected for output responsive to user input. The selected image may also be stored in memory to retain the image for a longer period of time. Advantageously, in accordance with some embodiments of the present invention, the image that is selected for display responsive to user input is the image that was stored in the buffers immediately before the user input. This image may have less distortion as the user was not pressing the release or capture button when this image was obtained. In other embodiments, the various images stored in the buffers 230 may be displayed to the user and the user may select one or more of those images as the final image to be saved.

The flowchart of FIG. 4 illustrates the architecture, functionality, and operations of embodiments of methods, electronic devices, and/or computer program products for processing image data. In this regard, each block represents a module, segment, or portion of code, which comprises one or more executable instructions for implementing the specified logical function(s). It should also be noted that in other implementations, the function(s) noted in the blocks may occur out of the order noted in FIG. 4. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of operating an electronic device, comprising:
providing a plurality of buffers;
storing consecutive images in respective ones of the plurality of buffers; and
selecting at least one of the stored images for output responsive to user input.

2. The method of claim 1, wherein storing the consecutive images, comprises:
compressing the consecutive images.

3. The method of claim 2, wherein storing the consecutive images further comprises:
scaling the consecutive images before compressing the consecutive images.

4. The method of claim 1, further comprising:
scaling the consecutive images; and
outputting the scaled consecutive images before selecting at least one of the stored images for output.

5. The method of claim 1, wherein the plurality of buffers comprises a circular queue.

6. The method of claim 1, wherein selecting at least one of the stored images for output comprises:
selecting the image that was stored in the plurality of buffers immediately before the user input responsive to the user input.

7. The method of claim 1, wherein selecting at least one of the stored images for output comprises:
displaying the stored images responsive to the user input; and
receiving a selection of at least one of the stored images from the user responsive to displaying the stored images.

8. The method of claim 1, wherein the electronic device is a mobile terminal comprising a camera and/or a video recorder.

9. An electronic device, comprising:
an image sensor that is configured to receive consecutive images;
a plurality of buffers that are configured to respectively store the consecutive images therein; and
a display that is configured to output a selected at least one of the stored images responsive to user input.

10. The device of claim 9, further comprising:
a compression engine that is configured to compress the consecutive images; and
wherein the plurality of buffers are further configured to respectively store the compressed consecutive images therein.

11. The device of claim 10, further comprising:
a scaling unit that is configured to scale the consecutive images; and
wherein the compression engine is further configured to compress the scaled consecutive images.

12. The device of claim 9, further comprising:
a scaling unit that is configured to scale the consecutive images; and
wherein the display is further configured to output the scaled consecutive images before the selected at least one of the stored images is output responsive to the user input.

13. The device of claim 9, wherein the plurality of buffers comprises a circular queue.

14. The device of claim 9, wherein the display is further configured to output the image that was stored in the plurality of buffers immediately before the user input as the selected at least one of the stored images responsive to the user input.

15. The device of claim 9, wherein the display is further configured to display the stored images responsive to the user input and to receive a selection of at least one of the stored images from the user responsive to displaying the stored images.

16. The device of claim 9, wherein the electronic device is a mobile terminal comprising a camera and/or a video recorder.

17. An electronic device, comprising:
a plurality of buffers;
means for storing consecutive images in respective ones of the plurality of buffers; and
means for selecting at least one of the stored images for output responsive to user input.

18. The device of claim 17, wherein the means for storing the consecutive images, comprises:
means for compressing the consecutive images.

19. The device of claim 18, wherein the means for storing the consecutive images further comprises:
means for scaling the consecutive images before compressing the consecutive images.

20. The device of claim 17, further comprising:
means for scaling the consecutive images; and
means for outputting the scaled consecutive images before selecting at least one of the stored images for output.

21. The device of claim 17, wherein the plurality of buffers comprises a circular queue.

22. The device of claim 17, wherein the means for selecting at least one of the stored images for output comprises:
means for selecting the image that was stored in the plurality of buffers immediately before the user input responsive to the user input.

23. The device of claim 17, wherein the means for selecting at least one of the stored images for output comprises:
means for displaying the stored images responsive to the user input; and
means for receiving a selection of at least one of the stored images from the user responsive to displaying the stored images.

24. The device of claim 17, wherein the electronic device is a mobile terminal comprising a camera and/or a video recorder.

25. A computer program product for operating an electronic device, comprising:
a computer readable storage medium having computer readable program code embodied therein, the computer readable program code comprising:
computer readable program code configured to store consecutive images in respective ones of a plurality of buffers; and
computer readable program code configured to select at least one of the stored images for output responsive to user input.

26. The computer program product of claim 25, wherein the computer readable program code configured to store the consecutive images, comprises:
computer readable program code configured to compress the consecutive images.

27. The computer program product of claim 26, wherein the computer readable program code configured to store the consecutive images further comprises:
computer readable program code configured to scale the consecutive images before compressing the consecutive images.

28. The computer program product of claim 25, further comprising:
computer readable program code configured to scale the consecutive images; and
computer readable program code configured to output the scaled consecutive images before selecting at least one of the stored images for output.

29. The computer program product of claim 25, wherein the plurality of buffers comprise a circular queue.

30. The computer program product of claim 25, wherein the computer readable program code configured to select at least one of the stored images for output comprises:
computer readable program code configured to select the image that was stored in the plurality of buffers immediately before the user input responsive to the user input.

31. The computer program product of claim 25, wherein the computer readable program code configured to select at least one of the stored images for output comprises:
computer readable program code configured to display the stored images responsive to the user input; and
computer readable program code configured to receive a selection of at least one of the stored images from the user responsive to displaying the stored images.

32. The computer program product of claim 25, wherein the electronic device is a mobile terminal comprising a camera and/or a video recorder.
